(19) United States
(12) Patent Application Publication
(10) Pub. No.: US 2021/0230358 A1
(43) Pub. Date: Jul. 29, 2021

(54) THERMOPLASTIC COPOLYMERS WITH A HIGH SULFUR CONTENT AND PROCESS FOR THEIR PREPARATION

(71) Applicant: ENI S.P.A., Roma (IT)

(72) Inventors: Alberto Renato De Angelis, San Donato Milanese (IT); Marco Guidolin, Porto Marghera (IT)

(73) Assignee: ENI S.P.A., Roma (IT)

(21) Appl. No.: 17/053,440

(22) PCT Filed: May 10, 2019
(86) PCT No.: PCT/IB2019/053858

§ 371 Date: Nov. 6, 2020

(30) Foreign Application Priority Data
May 11, 2018 (IT) 102018000005270

(51) Int. Cl. C08G 61/08; C08K 3/06; C08K 5/372

(52) U.S. Cl. CPC C08G 61/08; C08K 5/372; C08K 3/06

(57) ABSTRACT

Thermoplastic copolymer with a high sulphur content comprising sulphur in a quantity higher than or equal to 40% by weight, preferably ranging from 45% by weight to 90% by weight, with respect to the total weight of said thermoplastic copolymer, and at least one monomer having general formula (I) wherein: R₁ and R₂, equal to or different from each other, represent a hydrogen atom; or they are selected from C₁-C₂₀, preferably C₁-C₁₅, linear or branched alkyl groups, C₂-C₂₀, preferably C₂-Cᵢ₅, linear or branched alkenyl groups, C₂-C₂₀, preferably C₂-C₁₅, linear or branched alkylidene groups; or R₁ and R₂, may optionally be bound to one another so as to form, together with the other atoms to which they are bound, a cycloalkene containing from 4 to 6 carbon atoms, saturated, unsaturated, or aromatic, optionally substituted with C₁-C₂₀, preferably C₁-C₁₅, linear or branched alkyl groups, said cycle optionally containing heteroatoms such as, for example, oxygen, sulphur, nitrogen, silicon, phosphorus, selenium; said monomer having the general formula (I) being present in a quantity lower than or equal to 60% by weight, preferably ranging from 10% by weight to 55% by weight, with respect to the total weight of said thermoplastic copolymer. Said thermoplastic copolymer with a high sulphur content exhibits a high glass transition temperature (T_{g}) [i.e. glass transition temperature (T_{g}) higher than or equal to 80° C.] and good mechanical properties and can be advantageously used, as such or in admixture with other (co)polymers (for example, styrene, divinylbenzene), in a great many applications such as, for example, packaging, electronics, household appliances, computer cases, CD cases, kitchens, laboratories, office and medical items, in buildings and in construction.

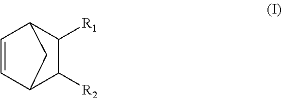

The present invention relates to a thermoplastic copolymer with a high sulphur content.

More particularly, the present invention relates to a thermoplastic copolymer with a high sulphur content comprising sulphur in a quantity higher than or equal to 40% by weight, preferably ranging from 45% by weight to 90% by weight, with respect to the total weight of said thermoplastic copolymer, and at least one monomer having a norbornene structure in a quantity lower than or equal to 60% by weight, preferably ranging from 10% by weight to 55% by weight, with respect to the total weight of said thermoplastic copolymer.

The present invention also relates to a process for preparing said thermoplastic copolymer with a high sulphur content.

Said thermoplastic copolymer with a high sulphur content exhibits a high glass transition temperature (T_{g}) [i.e. glass transition temperature (T_{g}) higher than or equal to 80° C.] and good mechanical properties and can be advantageously used, as such or in admixture with other (co)polymers (for example, styrene, divinylbenzene), in a great many applications such as, for example, packaging, electronics, household appliances, computer cases, CD cases, kitchens, laboratories, office and medical items, in buildings and in construction.

It is known that in the oil industry, during the production of natural gas and oil, ever larger quantities of elemental sulphur are produced, the production surplus of which currently exceeds one million tonnes per year with a tendency to further increase as and when new fields are developed in which the content of hydrogen sulphide (H₂S) and elemental sulphur will become increasingly significant. The surplus of world production of sulphur not only generates a depression of its market price, as a result of which transport costs can have a negative effect on its marketing, but it is also the cause of significant environmental problems due to the storage of large quantities of elemental sulphur. In fact, if storage takes place in the open air or underground, the aggression of atmospheric agents can cause contamination of the surrounding areas. In this regard, it is worth mentioning, for example, the phenomenon known as “dusting” or dispersion of sulphur powder which, in turn, can produce acidic substances (for example, sulphuric acid) through oxidation.

Studies have been carried out, with the aim of using elemental sulphur for the preparation of polymers with a high sulphur content.

For example, patent application US 2014/0199592 describes a polymeric composition comprising a sulphur copolymer, in a quantity of at least about 50% by weight with respect to the copolymer, and one or more monomers selected from the group consisting of ethylenically unsaturated monomers, epoxy monomers, thiirane monomers, in a quantity ranging from about 0.1% by weight to about 50% by weight with respect to the copolymer. In the definition of ethylenically unsaturated monomers, cyclopentadienyl compounds such as cyclopentadiene and dicyclopentadiene are specifically excluded. The above-mentioned polymeric composition with a high sulphur content is said to be advantageously usable in electrochemical cells and in optical elements.

Griebel J. J. et al., in “Advanced Materials” (2014), Vol. 26, pages 3014-3018, describe the preparation of thermoplastic copolymers with a high sulphur content obtained through the reverse vulcanization technique by reacting sulphur and 1,3 -diisopropenylbenzene (DIB). The aforementioned thermoplastic copolymers are said to have a good transparency in the IR spectrum and a high refractive index (n˜1.8). Moreover, the aforementioned thermoplastic copolymers are said to be advantageously usable as optical materials transparent to infra-red light.

However, the above-mentioned copolymers with a high sulphur content appear to be fragile, in particular at temperatures below their glass transition temperature. Moreover, said copolymers with a high sulphur content can be advantageously used only for particular applications.

The Applicant has therefore posed the problem of finding copolymers with a high sulphur content that are capable of being advantageously usable in fields of large consumption where rigidity and, consequently, high glass transition temperatures (T_{g}) and good mechanical properties, are generally required.

The Applicant has found thermoplastic copolymers with a high sulphur content having a high glass transition temperature (T_{g}) [i.e. glass transition temperature (T_{g}) higher than or equal to 80° C.] and good mechanical properties. Said thermoplastic copolymers with a high sulphur content, due to their characteristics, are rigid and can be advantageously used in a great many applications such as, for example, packaging, electronics, household appliances, computer cases, CD cases, kitchens, laboratories, office and medical items, in buildings and in construction. Furthermore, said thermoplastic copolymers with a high sulphur content have a significantly lower cost than the polymers that are normally used in the aforementioned applications such as, for example, styrene, phenolic resins. Furthermore, said thermoplastic copolymers with a high sulphur content not only allow significant quantities of elemental sulphur to be used for their production, thus reducing the surplus thereof, but also enable the use of carcinogenic substances (for example, formaldehyde in the case of production of phenolic resins) to be avoided.

The subject of the present invention is therefore a thermoplastic copolymer with a high sulphur content comprising sulphur in a quantity higher than or equal to 40% by weight, preferably ranging from 45% by weight to 90% by weight, with respect to the total weight of said thermoplastic copolymer, and at least one monomer having general formula (I):

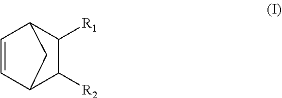

wherein:
R₁ and R₂, equal to or different from each other, represent a hydrogen atom; or they are selected from C₁-C₂₀, preferably C₁-C₁₅, linear or branched alkyl groups, C₂-C₂₀, preferably C₂-C₁₅, linear or branched alkenyl groups, C₂-C₂₀, preferably C₂-C₁₅, linear or branched alkylidene groups;
or R₁ and R₂, may optionally be bound to one another so as to form, together with the other atoms to which they are bound, a cycloalkene

containing from 3 to 6 carbon atoms, said monomer having the general formula (I) being present in a quantity lower than or equal to 60% by weight, preferably ranging from 10% by weight to 55% by weight, with respect to the total weight of said thermoplastic copolymer.

For the purpose of the present description and of the following claims, definitions of the numerical ranges always comprise the extremes unless otherwise specified.

For the purpose of the present description and of the following claims, the term “comprising” also includes the terms “which essentially consists of” or “which consists of”.

For the purpose of the present description and of the following claims, the term “C₁-C₂₀ alkyl groups” means alkyl groups having from 1 to 20 carbon atoms, whether linear or branched. Specific examples of C₁-C₂₀ alkyl groups are: methyl, ethyl, n-propyl, iso-propyl, n-butyl, s-butyl, iso-butyl, tent-butyl, pentyl, hexyl, heptyl, octyl, n-nonyl, n-decyl, 2-butyloctyl, 5-methylhexyl, 4-ethylhexyl, 2-ethylheptyl, 2-ethylhexyl.

For the purpose of the present description and of the following claims, the term “C₂-C₂₀ alkenyl groups” means alkenyl groups having from 2 to 20 carbon atoms, whether linear or branched. Specific examples of C₂-C₂₀ alkenyl groups are: ethenyl (vinyl), 2-propenyl, 1-butenyl, 2-butenyl, 3-butenyl, 1-pentenyl, 2-pentenyl, 3-pentenyl, 1-hexenyl, 2-hexenyl , 3-hexenyl.

For the purpose of the present description and of the following claims, the term “C₂-C₂₀ alkylidene groups” means alkylidene groups having from 2 to 20 carbon atoms, whether linear or branched. Specific examples of C₂-C₂₀ alkylidene groups are: ethylidene, propylidene, iso-propylidene butylidene, iso-butylidene, amylidene, iso-amylidene.

For the purpose of the present description and of the following claims, the term “cycloalkene” means a system containing a ring having from 3 to 6 carbon atoms and a double bond. Specific examples of cycloalkene are: cyclopropene, cyclobutene, cyclopentene, cyclohexene, cycloheptene.

According to a preferred embodiment of the present invention, said monomer having general formula (I) can be selected, for example, from: dicyclopentadiene, 5-ethylidene-2-norbonene, 5-vinyl-2-norbornene, or mixtures thereof.

According to a preferred embodiment of the present invention, said thermoplastic copolymer with a high sulphur content comprises sulphur in a quantity equal to 50% by weight with respect to the total weight of said thermoplastic copolymer, and at least one monomer having general formula (I):

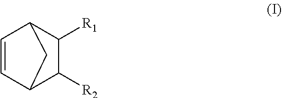

wherein R₁ and R₂, are bound to one another so as to form, together with the other atoms to which they are bound, a cyclopentene, said monomer having general formula (I) being present in a quantity equal to 50% by weight with respect to the total weight of said thermoplastic copolymer.

According to a further preferred embodiment of the present invention, said thermoplastic copolymer with a high sulphur content comprises sulphur in a quantity equal to 60% by weight with respect to the total weight of said thermoplastic copolymer and at least one monomer having general formula (I):

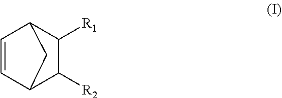

wherein R₁ and R₂, are bound together so as to form, together with the other atoms to which they are bound, a cyclopentene, said monomer having general formula (I) being present in a quantity equal to 40% by weight with respect to the total weight of said thermoplastic copolymer.

According to a further preferred embodiment of the present invention, said thermoplastic copolymer with a high sulphur content comprises sulphur in a quantity equal to 50% by weight with respect to the total weight of said thermoplastic copolymer, and at least one monomer having general formula (I):

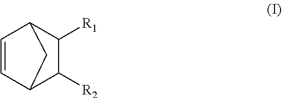

wherein R₁ is hydrogen and R₂ is ethylidene, said monomer having general formula (I) being present in a quantity equal to 50% by weight with respect to the total weight of said thermoplastic copolymer.

According to a preferred embodiment of the present invention, said thermoplastic copolymer with a high sulphur content can have a glass transition temperature (T_{g}) higher than or equal to 80° C., preferably ranging from 85° C. to 160° C.

Said glass transition temperature (T_{g}) was determined by thermal analysis (“Differential Scanning calorimetry”) which was carried out as reported below at paragraph “Analysis and characterisation methodology”.

As stated above, the present invention also relates to a process for preparing said thermoplastic copolymer with a high sulphur content.

Accordingly, a further subject of the present patent application is a process for the preparation of a thermoplastic copolymer with a high sulphur content comprising:
(i) melting the sulphur at a temperature ranging from 120° C. to 190° C., preferably ranging from 140° C. and 180° C., for a time ranging from 1 minute to 15 minutes, preferably ranging from 2 minutes to 12 minutes, obtaining sulphur in liquid form;
(ii) reacting the sulphur in liquid form obtained in step (i) with at least one monomer having general formula (I) at a temperature ranging from 120° C. to 190° C., preferably ranging from 140° C. to 180° C., for a time ranging from 1 minute to 180 minutes, preferably ranging from 10 minutes to 120 minutes, obtaining a liquid pre-polymer;
(iii) pouring the liquid pre-polymer obtained in step (ii) into a mold and maintaining said mold at a temperature ranging from 100° C. to 180° C., preferably ranging from 120° C. to 170° C., for a time ranging from 1 hour to 24 hours, preferably ranging from 2 hours to 15 hours, obtaining a thermoplastic copolymer with a high sulphur content.

According to a further embodiment of the present invention, the aforementioned step (ii) can be carried out in the presence of at least one radical initiator, said radical initiator being stable at a temperature higher than or equal to 105° C.

According to a preferred embodiment of the present invention, said radical initiator can be selected, for example, from allyl disulfide, 2,2′-azobisisobutyrronitrile (AIBN), 1,1′-azobi s(cyclohexanecarbonitrile) benzenesulfonylhydrazine (BSH), p-toluensulfonylhydrazine (TSH), or mixtures thereof. Allyl disulfide is preferred.

According to a preferred embodiment of the present invention, said radical initiator can be used in said step (ii) in a quantity lower than or equal to 1% by weight, preferably ranging from 0.2% by weight to 0.5% by weight, with respect to the total weight of the reaction mixture (i.e. the sulphur+monomer+radical initiator mixture).

For the purpose of the process which is the subject-matter of the present invention, the mould used in the aforesaid step (iii) can preferably be made of Teflon or silicone.

In accordance with a preferred embodiment of the present invention the sulphur used in said step (i) is elemental sulphur.

For the purpose of the process which is the subject-matter of the present invention, said elemental sulphur is preferably in the form of powder or flakes. Under ambient conditions (i.e. at ambient temperature and pressure), elemental sulphur exists in an orthorhombic crystalline form (eight-sided ring) (S₈) and has a melting temperature ranging from 120° C. to 124° C. Said elemental sulphur in orthorhombic crystalline form (S₈), at a temperature above 159° C., is subject to polymerisation by ring opening (“Ring Opening Polymerisation”-ROP) and is transformed into a linear polymer chain with two free radicals at the ends. Said polymeric linear chain is metastable and therefore tends, more or less slowly depending on the conditions, to revert back into the orthorhombic crystalline form (S₈).

For the purpose of the process that is the subject-matter of the present invention, said elemental sulphur is in orthorhombic crystalline form (S₈), said shape being generally the most stable, the most accessible and the least expensive. However, it should be noted that, for the purpose of the present invention, the other allotropic forms of sulphur can also be used, such as, for example, the cyclic allotropic forms which derive from thermal processes to which elemental sulphur can be subjected in orthorhombic crystalline form (S₈). It should also be noted that any sulphur species which, when heated, yields species capable of being subjected to radical or anionic polymerisation, can be used for the purpose of the process that is the subject-matter of the present invention.

As stated above, said thermoplastic copolymer with a high sulphur content can be advantageously used, as such or in admixture with other (co)polymers (for example, styrene, divinylbenzene), in a great many applications such as, for example, packaging, electronics, household appliances, computer cases, CD cases, kitchen, laboratory, office and medical items, in buildings and in construction.

Accordingly, a further aim of the present invention is use of said thermoplastic copolymer with a high sulphur content, as such or in admixture with other (co)polymers (for example, styrene, divinylbenzene), in a great many applications such as, for example, packaging, electronics, household appliances, computer cases, CD cases, kitchens, laboratories, office and medical items, in buildings and in construction.

In order to better understand the present invention and to put it into practice, some illustrative and non-limiting examples thereof are given below.

### EXAMPLES

### Analysis and Characterisation Methodology

The analysis and characterisation methodologies listed below were used.

Thermal Analysis (DSC)

The DSC thermal analysis (“Differential Scanning calorimetry”), for the purpose of determining the glass transition temperature (T_{g}) of the copolymers obtained, was carried out using a Perkin Elmer Pyris differential scanning calorimeter, using the following thermal programme:

cooling from room temperature (T=25° C.) to −60° C. at a rate of −5° C./minute;

heating from −60° C. to +150° C. at a rate of +10° C./minute (first scan);

cooling from +150° C. to −60° C. at a rate of −5° C./minute;

heating from −60° C. to +150° C. at a rate of +10° C./minute (second scan); working under a stream of nitrogen (N₂) at 70 ml/minute.

### Example 1

### Invention

### Synthesis of Copolymer With Sulphur (50% by Weight) and Dicyclopentadiene (50% by Weight)

5 g of pure sulphur [elemental sulphur in orthorhombic crystalline form (S₈) of Sigma-Aldrich] was charged into a 30 ml glass autoclave equipped with magnetic stirrer: the autoclave was heated to 160° C., in a thermostatic oil bath, and maintained at said temperature for 10 minutes, obtaining the melting of the sulphur, which becomes a yellow/orange coloured liquid. 5 g of dicyclopentadiene (purity>96%-Sigma-Aldrich) in a solid phase was then added to said liquid: the whole was maintained, under stirring, at 160° C., until a solution was obtained which remained still fluid and assumed an intense red/burnished colour. The fluid solution thus obtained was poured into a Teflon mould which was closed and heated to 160° C. in an oven: said fluid solution was maintained at said temperature, for 6 hours, obtaining a copolymer that was black in colour and with a translucent appearance.

Said copolymer was subjected to DSC thermal analysis (“Differential Scanning Calorimetry”) working as described above, for the purpose of measuring the glass transition temperature (T_{g}), which was found to be 130° C. A further heat treatment was carried out on the polymer at 160° C. for 12 hours. The glass transition temperature measured working as described above was found to be above 150° C.

Said copolymer was found to be highly resistant and difficult to break.

### Example 2

### Invention

### Synthesis of Copolymer With Sulphur (60% by Weight) and Dicyclopentadiene 00% by Weight)

6 g of pure sulphur [elemental sulphur in orthorhombic crystalline form (S₈) of Sigma-Aldrich] was charged into a 30 ml glass autoclave equipped with magnetic stirrer: the autoclave was heated to 160° C., in a thermostatic oil bath, and maintained at said temperature for 10 minutes, obtaining the melting of the sulphur, which becomes a yellow/orange coloured liquid. 4 g of dicyclopentadiene (purity>96%-Sigma-Aldrich) in a solid phase was then added to said liquid: the whole was maintained, under stirring, at 160° C., until a solution which remained still fluid and assumed an intense red/burnished colour was obtained. The fluid solution thus obtained was poured into a Teflon mould which was closed and heated to 160° C. in an oven: said fluid solution was maintained at said temperature for 3 hours, obtaining a copolymer that was black in colour and with a translucent appearance.

Said copolymer was subjected to DSC thermal analysis (“Differential Scanning Calorimetry”) working as described above, for the purpose of measuring the glass transition temperature (T_{g}), which was found to be 99° C. A further heat treatment was then carried out on the polymer at 160° C. for 12 hours. The glass transition temperature measured working as described above was found to be above 124° C.

Said copolymer was found to be highly resistant and difficult to break.

### Exmple 3

### Invention

### Synthesis of Copolymer With Sulphur (60% by Weight) and Dicyclopentadiene (40% by Weight)

6 g of pure sulphur were charged into a 30 ml glass autoclave equipped with magnetic stirrer [elemental sulphur in orthorhombic crystalline form (S₈) of Sigma-Aldrich]: the autoclave was heated to 160° C., in a thermostatic oil bath, and maintained at said temperature for 5 minutes, obtaining the melting of the sulphur, which becomes a yellow/orange coloured liquid. 4 ml of dicyclopentadiene (purity 95%-Versalis), liquid at ambient temperature (25° C.), was then added drop by drop to said liquid: the whole was maintained, under stirring, at 160° C., for 13 minutes, obtaining a solution, which remained still fluid, and assumed an intense red/brown colour. The fluid solution thus obtained was poured into a Teflon mould which was closed and heated to 160° C. in an oven: said fluid solution was maintained at said temperature, for 3 hours, obtaining a copolymer that was black in colour and with a translucent appearance.

Said copolymer was subjected to DSC thermal analysis (“Differential Scanning Calorimetry”) carried out as described above, for the purpose of measuring the glass transition temperature (T_{g}), which was found to be equal to 99° C.

A further heat treatment was then carried out on the polymer at 160° C. for 16 hours. The glass transition temperature measured operating as described above was found to be above 111° C.

Said copolymer was found to be highly resistant and difficult to break.

### Example 4

### Invention

### Synthesis of Copolymer With Sulphur (60% by Weight) and Dicyclopentadiene (40% by Weight) in the Presence of a Radical Initiator

6 g of pure sulphur [elemental sulphur in orthorhombic crystalline form (S₈) of Sigma-Aldrich] was charged into a 30 ml glass autoclave equipped with magnetic stirrer: the autoclave was heated to 160° C., in a thermostatic oil bath, and maintained at said temperature for 5 minutes, obtaining the melting of the sulphur, which becomes a yellow/orange coloured liquid. To said liquid were then added, in order, 0.04 ml of allyl disulfide (Sigma-Aldrich) and 4 g of dicyclopentadiene (purity>96%-Sigma-Aldrich): the whole was maintained, under stirring, at 160° C., until a solution was obtained which remained still fluid, and assumed an intense red/brown colour. The fluid solution thus obtained was poured into a Teflon mold which was closed up and heated to 160° C. in an oven: said fluid solution was maintained at said temperature for 3 hours, obtaining a copolymer that was black in colour and with a translucent appearance.

Said copolymer was subjected to DSC thermal analysis (“Differential Scanning Calorimetry”) working as described above, for the purpose of measuring the glass transition temperature (T_{g}), which was found to be 120° C. A further heat treatment was then carried out on the polymer at 160° C. for 16 hours. The glass transition temperature measured operating as described above was found to be above 140° C.

Said copolymer was found to be highly resistant and difficult to break.

### Example 5

### Invention

Synthesis of Copolymer With Sulphur (60% by weight) and Dicyclopentadiene 40% by Weight) in the Presence of a Radical Initiator

6 g of pure sulphur [elemental sulphur in orthorhombic crystalline form (S₈) of Sigma-Aldrich] was charged into a 30 ml glass autoclave equipped with magnetic stirrer: the autoclave was heated to 130° C., in a thermostatic oil bath, and maintained at said temperature for 10 minutes, obtaining the melting of the sulphur which becomes a yellow/orange coloured liquid. To said liquid were then added, in order, 0.04 ml of allyl disulfide (Sigma-Aldrich) and 4 g of dicyclopentadiene (purity>96%-Sigma-Aldrich): the whole was maintained, under stirring, at 130° C., for 120 minutes, obtaining a solution which remained still fluid, and assumed an intense red/brown colour. The fluid solution thus obtained was poured into a Teflon mould which was closed and heated to 160° C. in an oven: said fluid solution was maintained at said temperature for 3 hours, obtaining a copolymer that was black in colour and with a translucent appearance.

Said copolymer was subjected to DSC thermal analysis (“Differential Scanning Calorimetry”) working as described above, for the purpose of measuring the glass transition temperature (T_{g}), which was found to be 77° C. A further heat treatment was then carried out on the polymer at 160° C. for 16 hours. The glass transition temperature measured operating as described above was found to be above 94° C.

Said copolymer was found to be highly resistant and difficult to break.

### Example 6

### Invention

### Synthesis of Copolymer With Sulphur (60% by Weight) and Dicyclopentadiene (40% by Weight) in the Presence of a Radical Initiator

30 g of pure sulphur [elemental sulphur in orthorhombic crystalline form (S₈) of Sigma-Aldrich] were charged into a 100 ml glass autoclave equipped with magnetic stirrer: the autoclave was heated to 140° C. in a thermostatic oil bath, and maintained at said temperature for 10 minutes, obtaining the melting of the sulphur, which becomes a yellow/orange coloured liquid. To said liquid were then added, in order, 0.2 ml of allyl disulfide (Sigma-Aldrich) and, gradually over 40 minutes, at about 0.5 g/minute, 20 g of dicyclopentadiene (purity>96%-Sigma-Aldrich): the whole was maintained, under stirring, at 140° C., until a solution was obtained which remained still fluid, and assumed an intense red/brown colour. The fluid solution thus obtained was poured into a Teflon mould which was closed and heated to 150° C. in an oven: said fluid solution was maintained at said temperature, for 16 hours, obtaining a copolymer that was black in colour and with a translucent appearance.

Said copolymer was subjected to DSC thermal analysis (“Differential Scanning Calorimetry”) carried out as described above, for the purpose of measuring the glass transition temperature (T_{g}),which was found to be equal to 129° C.

Said copolymer was found to be highly resistant and difficult to break.

### Example 7

### Invention

Synthesis of Copolymer With Sulphur (50% by Weight) and 5-ethylidene-2-norbornene (50% by Weight)

5 g of pure sulphur [elemental sulphur in orthorhombic crystalline form (S₈) of Sigma-Aldrich] was charged into a 60 ml glass autoclave equipped with magnetic stirrer: the autoclave was heated to 160° C., in a thermostatic oil bath, and maintained at said temperature for 5 minutes obtaining the melting of the sulphur which becomes a yellow/orange coloured liquid. To said liquid were then added, drop by drop, 5 g of 5-ethylidene-2-norbornene (purity 99%-Sigma-Aldrich) previously melted: the whole was maintained, under stirring, at 160° C., for 3 minutes, obtaining a solution, which still remains fluid, and assumed an intense red colour. The fluid solution thus obtained was poured into a Teflon mold which was closed up and heated to 160° C. in an oven: said fluid solution was maintained at said temperature, for 12 hours, obtaining a copolymer black in colour and with a translucent appearance.

Said copolymer was subjected to DSC thermal analysis (“Differential Scanning Calorimetry”) carried out as described above, for the purpose of measuring the glass transition temperature (T_{g}) which was found to be equal to 87° C.

Said copolymer was found to be very resistant and difficult to break.

### Example 8

### Comparative

### Synthesis of Sulphur/DIB Copolymer With Sulphur Content of 70% by Weight

A comparative sulphur/DIB (1,3-diisopropenylbenzene) copolymer was prepared as follows.

17.5 g of pure sulphur [elemental sulphur in orthorhombic crystalline form (S₈) of Sigma-Aldrich] was charged into a 60 ml glass autoclave equipped with magnetic stirrer: the autoclave was heated to 185° C., in a thermostatic oil bath, and maintained at said temperature for 5 minutes obtaining the melting of the sulphur, which becomes a yellow/orange coloured liquid. 7.5 g of 1,3-diisopropenylbenzene (DIB) (Sigma-Aldrich) was then added drop by drop to said liquid: the whole was maintained under stirring at 185° C. for 3 minutes obtaining a solution, which still remains fluid, and assumed an intense red colour. The fluid solution thus obtained was poured into a Teflon mold which was closed and heated to 185° C. in an oven: said fluid solution was maintained at said temperature, for 3 hours, obtaining a red copolymer with a transparent appearance.

Said copolymer was subjected to DSC thermal analysis (“Differential Scanning Calorimetry”) carried out as described above, for the purpose of measuring the glass transition temperature (T_{g}), which was found to be equal to 19.8° C.

Said copolymer, at temperatures higher than the glass transition temperature (T_{g}), softens giving rise to a semi-fluid product of high viscosity while, at temperatures lower than the glass transition temperature (T_{g}), it was found to be fragile and easily subject to breakage by applying a moderate pressure.

### Example 9

### Comparative

### Synthesis of Sulphur/DIB Copolymer With Sulphur Content of 50% by Weight

A comparative sulphur/DIB (1,3-diisopropenylbenzene) copolymer was prepared as follows.

12.5 g of pure sulphur [elemental sulphur in orthorhombic crystalline form (S₈) of Sigma-Aldrich] was charged into a 60 ml glass autoclave equipped with a magnetic stirrer: the autoclave was heated to 185° C., in a thermostatic oil bath, and maintained at said temperature for 5 minutes, obtaining the melting of the sulphur, which becomes a yellow-coloured liquid. 12.5 g of 1,3-diisopropenylbenzene (DIB) (Sigma-Aldrich) was then added drop by drop to said liquid: the whole was maintained under stirring at 185° C. for 3 minutes. obtaining a solution which remained still fluid, and assumed an intense red colour. The fluid solution thus obtained was poured into a Teflon mould which was closed and heated to 185° C. in an oven: said fluid solution was maintained at said temperature, for 3 hours, obtaining a red copolymer with a transparent appearance.

Said copolymer was subjected to DSC thermal analysis (“Differential Scanning Calorimetry”) carried out as described above, for the purpose of measuring the glass transition temperature (T_{g}), which was found to be equal to 40° C.

Said copolymer, at temperatures higher than the glass transition temperature (T_{g}), softens giving rise to a semi-fluid product of high viscosity while, at temperatures below the glass transition temperature (T_{g}), it was found to be fragile and easily subject to breakage by applying a moderate pressure.

1. Thermoplastic copolymer with a high sulphur content comprising sulphur in a quantity higher than or equal to 40% by weight, with respect to the total weight of said thermoplastic copolymer, and at least one monomer having general formula (I): 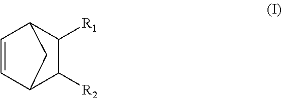
wherein:
R₁ and R₂, equal to or different from each other, represent a hydrogen atom; or are selected from C₁-C₂₀, linear or branched alkyl groups, C₂-C₂₀, or branched alkenyl groups, C₂-C₂₀, linear or branched alkylidene groups;
or R₁ and R₂, may optionally be bound to one another so as to form, together with the other atoms to which they are bound, a cycloalkene containing from 3 to 6 carbon atoms;
said monomer having general formula (I) being present in a quantity lower than or equal to 60% by weight, preferably ranging from 10% by weight to 55% by weight, with respect to the total weight of said thermoplastic copolymer.

2. Thermoplastic copolymer with a high sulphur content according to claim 1, wherein said monomer having general formula (I) is selected from: dicyclopentadiene, 5-ethylidene-2-norbonene, 5-vinyl-2-norbornene, or mixtures thereof.

3. Thermoplastic copolymer with a high sulphur content according to claim 1, wherein said thermoplastic copolymer with a high sulphur content comprises sulphur in a quantity equal to 50% by weight with respect to the total weight of said thermoplastic copolymer and at least one monomer having general formula (I): 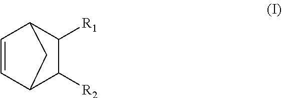
wherein R₁ and R₂, are bound to one another so as to form, together with the other atoms to which they are bound, a cyclopentene, said monomer having the general formula (I) being present in a quantity equal to 50% by weight with respect to the total weight of said thermoplastic copolymer.

4. Thermoplastic copolymer with a high sulphur content according to claim 1, wherein said thermoplastic copolymer with a high sulphur content comprises sulphur in a quantity equal to 60% by weight with respect to the total weight of said thermoplastic copolymer and at least one monomer having general formula (I): 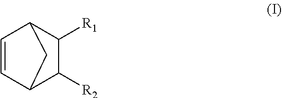
wherein R₁ and R₂, are bound to one another so as to form, together with the other atoms to which they are bound, a cyclopentene, said monomer having general formula (I) being present in a quantity equal to 40% by weight with respect to the total weight of said thermoplastic copolymer.

5. Thermoplastic copolymer with a high sulphur content according to claim 1, wherein said thermoplastic copolymer with a high sulphur content comprises sulphur in a quantity equal to 50% by weight with respect to the total weight of said thermoplastic copolymer and at least one monomer having general formula (I): 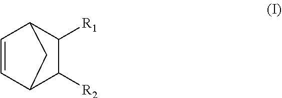
wherein R₁ is hydrogen and R₂ is ethylidene, said monomer having general formula (I) being present in a quantity equal to 50% by weight with respect to the total weight of said thermoplastic copolymer.

6. Thermoplastic copolymer with a high sulphur content according to claim 1, wherein said thermoplastic copolymer with a high sulphur content has a glass transition temperature (T_{g}) higher than or equal to 80° C., preferably ranging from 85° C. to 160° C.

7. Process for the preparation of a thermoplastic copolymer with a high sulphur content comprising:
(i) melting the sulphur at a temperature ranging from 120° C. to 190° C., preferably ranging from 150° C. to 180° C., for a time ranging from 1 minute to 15 minutes, preferably ranging from 2 minutes to 10 minutes, obtaining sulphur in liquid form;
(ii) reacting the sulphur in liquid form obtained in step (i) with at least one monomer having general formula (I) at a temperature ranging from 120° C. to 190° C., preferably ranging from 150° C. to 180° C., for a time ranging from 1 minute to 180 minutes, preferably ranging from 10 minutes to 120 minutes, obtaining a liquid pre-polymer;
(iii) pouring the liquid pre-polymer obtained in step (i) into a mould and maintaining said mould at a temperature ranging from 100° C. to 180° C., preferably ranging from 120° C. to 170° C., for a time ranging from 1 hour to 24 hours, preferably ranging from 2 hours to 15 hours, obtaining a thermoplastic copolymer with a high sulphur content.

8. Process for the preparation of a thermoplastic copolymer with a high sulphur content according to claim 7, wherein:
said step (ii) is carried out in the presence of at least one radical initiator, said radical initiator being stable at a temperature higher than or equal to 105° C.; and/or
said radical initiator is selected from allyl disulphide, 2,2′-azobisisobutyrronitrile (AIBN), 1,1′-azobis(cyclohexanecarbonitrile) benzenesulfonylhydrazine (BSH), p-toluensulfonylhydrazine (TSH), or mixtures thereof; allyl disulphide is preferred; and/or
said radical initiator is used in said step (ii) in a quantity lower than or equal to 1% by weight, preferably ranging from 0.2% by weight to 0.5% by weight, with respect to the total weight of the reaction mixture (i.e. the sulphur+monomer+radical initiator mixture).

9. Process for the preparation of a thermoplastic copolymer with a high sulphur content according to claim 7, wherein the sulphur used in said step (i) is elemental sulphur.

10. Use of a thermoplastic copolymer with a high sulphur content according to claim 1, as such or in admixture with other (co)polymers such as styrene, divinylbenzene, in packaging, electronics, electrical appliances, computer cases, CD cases, kitchens, laboratories, office and medical items, in buildings and in construction.

11. Thermoplastic copolymer with a high sulphur content according to claim 1, wherein the sulphur ranges from 45% by weight to 90% by weight,

12. Thermoplastic copolymer with a high sulphur content according to claim 1, wherein C₁-C₂₀ linear or branched alkyl groups is C₁-C₁₅ linear or branched alkyl groups.

13. Thermoplastic copolymer with a high sulphur content according to claim 1, wherein C₁-C₂₀ linear or branched alkenyl groups is C₂-C_{15,}

14. Thermoplastic copolymer with a high sulphur content according to claim 1, wherein C₁-C₂₀ linear or branched alkylidene groups is C₂-C₁₅, linear or branched alkylidene groups.

15. Thermoplastic copolymer with a high sulphur content according to claim 1, said monomer is present in a range from 10% by weight to 55% by weight.

16. Process for the preparation of a thermoplastic copolymer with a high sulphur content of claim 7, wherein said melting the sulphur at a temperature ranging from 150° C. to 180° C., for a time ranging from 2 minutes to 10 minutes.

17. Process for the preparation of a thermoplastic copolymer with a high sulphur content of claim 7, wherein said reacting the sulphur at a temperature range from 150° C. to 180 ° C., for a time range from 10 minutes to 120 minutes.

18. Process for the preparation of a thermoplastic copolymer with a high sulphur content of claim 7, wherein said maintaining said mould at a temperature range from 120° C. to 170° C., for a time range from 2 hours to 15 hours.
